(19) United States
(12) Patent Application Publication
(10) Pub. No.: US 2004/0085360 A1
(43) Pub. Date: May 6, 2004

(54) Icon-based graphical user interface for text messaging

(75) Inventors: Gary T. Pratt, Lawrence, KS (US); Gabriel F. Braddy, Mission, KS (US); Chris Cobb, Los Angeles, CA (US)

Correspondence Address: PATTON BOGGS, PO BOX 270930, LOUISVILLE, CO, 80027, US

(73) Assignee: Hallmark Interactive, LLC, New York, NY

(21) Appl. No.: 10/430,626

(22) Filed: May 6, 2003

Related U.S. Application Data
(60) Provisional application No. 60/423,121, filed on Oct. 31, 2002.

(51) Int. Cl. G09G 5/00

(52) U.S. Cl. 345/773

(57) ABSTRACT

The wireless communication device GUI uses a hierarchical set of commands that integrate the displays generated on the graphical display with the standard 12-button telephone keypad. In particular, the graphical display produces an image of all or a selected part of the standard 12-button telephone keypad (for convenience, both options being noted as the “telephone keypad” herein) with iconic and textual representations of commands/functions being displayed juxtaposed to the image of the numeric key. The user can then activate a selected key on the telephone keypad to activate one of the displayed commands/functions. A home state is used to provide a baseline point of reference from which the user can select one of a plurality of basic functions that include reading messages, generating messages as well as accessing various administrative functions and predetermined stock message icons and/or cards.

### CROSS-REFERENCE TO RELATED APPLICATIONS

This application claims benefit of U.S. Provisional Application Serial No. 60/423,121 filed Oct. 31, 2002. The entirety of this provisional application is incorporated herein by reference.

### FIELD OF THE INVENTION

This invention relates to graphical user interfaces and in particular to a graphical user interface for use in a wireless communication device to enable a user to generate text-based messages in an efficient manner.

### PROBLEM

It is a problem in the field of wireless communication devices to provide a convenient and efficient interface that enables a user to generate and receive text-based messages. These text-based messages are generated by the user activating keys that are located on the wireless communication device to thereby input the content of the text-based message.

There is an inherent human factors design conflict between providing a wireless communication device that is small in size and one that has a graphical display with associated keyboard that is convenient to use. The typical wireless communication device is designed to be carried in the user's coat pocket or in a pouch that can be affixed to the user's belt. The dimensional constraints associated with such a form factor definition limit the size of the graphical display screen that can be provided to the user. In addition, there are three primary paths that have been taken to provide the user with a data entry capability: standard 12-button telephone keypad, QWERTY keyboard, soft keys defined on the graphical display. All of these options are limited by the minimal size of the key, whether physical or soft, that can be activated by the user without inadvertently activating an adjacent key.

The standard 12-button telephone keypad is presently used to enable textual data input by the user activating a selected key a predetermined number of times to thereby select one of the plurality of alphanumeric characters associated with this key. Thus, one key may be defined as “abc” and one activation of the key signifies the entry of the character “a”, while two successive activations of the key signifies the entry of the character “b”, while three successive activations of the key signifies the entry of the character “c”. The user must pause a minimum predetermined amount of time between each set of keystrokes to enable the wireless communications device to interpret the character selection. The use of such a paradigm is laborious and is useful only in instances where a limited and infrequent data entry is expected, such as administering a telephone directory resident in the wireless communication device.

The use of a full or even partial QWERTY keyboard is seldom a choice for a wireless communication device due to the number of keys and the physical arrangement of the keys required to enable the user to be comfortable with the data entry format. This option is most frequently used for larger wireless communication devices and therefore is not an option for the majority of wireless communication devices.

The use of soft keys provides an option to the designer of wireless communication devices, but this option has failed to result in a viable graphical user interface, since the implementations typically emulate the above-noted standard 12-button telephone keypad operation or simply provide a menu navigation capability.

Therefore, there is a need for a convenient and efficient interface that enables a user to generate and receive text-based messages using a wireless communication device.

### SOLUTION

The above described problems are solved and a technical advance achieved in the art by the present icon-based graphical user interface for text and multi-media messaging (termed “wireless communication device GUI” herein) that provides a new paradigm for generating and receiving text-based and multi-media messages. The wireless communication device GUI provides a convenient and efficient interface that enables a user to intuitively navigate through a library of graphical displays, generating or receiving text-based and multi-media messages on a wireless communication device.

The wireless communication device GUI uses a hierarchical set of commands that integrate the displays generated on the graphical display with the standard 12-button telephone keypad. In particular, the graphical display produces an image of all or a selected part of the standard 12-button telephone keypad (for convenience, both options being noted as the “telephone keypad” herein) with iconic and textual representations of commands/functions being displayed juxtaposed to the image of the numeric key. The user can then activate a selected key on the telephone keypad to activate one of the displayed commands/functions. A home page display is used to provide a baseline point of reference from which the user can select one of a plurality of basic functions that include reading messages, generating messages as well as accessing various administrative functions and predetermined stock message icons and/or cards.

The integration of the use of the display to graphically display both a navigation scheme as well as a set of options related to the telephone keypad enables the user to efficiently operate the wireless communication device GUI to manage the user's text-based and multi-media message needs.

### BRIEF DESCRIPTION OF THE DRAWINGS

FIG. 1 illustrates a wireless communication device with display employing the wireless communications device GUI displaying a home page;

FIG. 2 illustrates a hierarchical set of commands that integrate the displays generated on the graphical display with the standard 12-button telephone keypad;

FIG. 3 illustrates a set of arrow command keys of a wireless communication device that navigate throughout the wireless communications device GUI;

FIGS. 4A-4E illustrate various positional indicia reflecting a position within the hierarchical set of commands of the wireless communications device GUI;

FIGS. 5A-5D illustrate various different arrangements of the graphical display which produces an image of all or a selected part of the standard 12-button telephone keypad;

FIG. 6 illustrates an embodiment of the display of the present wireless communications device GUI home page display;

FIGS. 7A-7H illustrate an embodiment of the displays of the present wireless communications device GUI read functions;

FIGS. 8A-8O illustrate an embodiment of the displays of the present wireless communications device GUI write functions;

FIGS. 9A-9L illustrate an embodiment of the displays of the present wireless communications device GUI card functions;

FIGS. 10A-10F illustrate an embodiment of the displays of the present wireless communications device GUI address messages functions;

FIGS. 11A and 11B illustrate an embodiment of the displays of the present wireless communications device GUI edit address functions;

FIGS. 12A and 12B illustrate an embodiment of the displays of the present wireless communications device GUI edit identification functions;

FIGS. 13A-13D illustrate an embodiment of the displays of the present wireless communications device GUI edit groups functions; and

FIGS. 14A-14C illustrate an embodiment of the displays of the present wireless communications device GUI send, edit, and delete functions.

### DETAILED DESCRIPTION OF THE DRAWINGS

The present wireless communication device GUI comprises instructions that may be stored on any memory or circuitry in a wireless communication device. The wireless communication device GUI is employed on common wireless communication devices that contain processing and control circuitry that controls the overall operation of common wireless communication devices. Coupled to the processing and control circuitry are a display, a memory, a transceiver, a 12-button telephone keypad, a speaker, and a microphone commonly known to those skilled in the art. The speaker is used to generate sound, which is output through the earpiece. The microphone is used to receive sound through the mouthpiece. The transceiver, which is also coupled to the antenna, is used to transmit and receive (via the antenna) data, including audio data and various other types of data.

The processing and control circuitry may include one or more of devices such as general-purpose microprocessors, digital signal processors (DSPs), application specific integrated circuits (ASICs), various types of signal conditioning circuitry, including analog-to-digital converters, digital-to-analog converters, input/output buffers, etc. The memory may include one or more physical memory devices, which may include volatile storage devices, non-volatile storage devices, or both. For example, the memory may include both random access memory (RAM), read-only memory (ROM), various forms of programmable and/or erasable ROM (e.g., PROM, EPOM, EEPROM, etc.), flash memory, or any combination of such devices. The present wireless communications device GUI includes steps which, in various embodiments, may be carried out by elements of the processing and control circuitry (e.g., a microprocessor or a DSP) executing sequences of instructions. The instructions may be stored in a memory. Software instructions (or data) may be loaded into the wireless communications device from another device, such as a remote computer system, over the wireless connection.

In various embodiments, downloaded software instructions may be directly supported by the wireless communications device, in which case execution of the instructions may be performed directly upon their being received. In other cases, downloaded instructions may not be directly executable by the wireless communications device. Under these circumstances, the instructions may be executed using an interpreter, which interprets the instructions, or by otherwise executing instructions which convert the received instructions to instructions that can be directly executed. Certain embodiments of the present wireless communications device GUI may be carried out by hard-wired circuitry, rather than by executing software, or by a combination of hard-wired circuitry with software. Hence, it will be recognized that the present wireless communications device GUI is not limited to any specific combination of hardware circuitry and software, nor to any particular source for software instructions. Nonetheless, to facilitate description it is henceforth assumed that aspects of the present wireless communications device GUI are generally carried out through the execution of software instructions in the wireless communications device.

The overall operation of the present wireless communication device GUI is described in association with the attached figures which are diagrams of displays that are generated by the present wireless communication device GUI to enable a user to efficiently generate and receive text-based, icon-based, and multi-media messages on a wireless communication device. This wireless communication device GUI applies a content “skin” over an interface and navigation schema, to provide a user with an intuitive way of finding, organizing, creating, and sending interactive content.

To initiate the operation, a user selects the “Hallmark Hiya” (mobile communications application) option on their wireless communication device. The wireless communication device GUI overlays keypad functions on the user's wireless communication device. The wireless communication device GUI uses a hierarchical set of commands that integrate the displays generated on the graphical display with the standard 12-button telephone keypad. In particular, the graphical display produces an image of all (or a selected part) of the standard 12-button telephone keypad (for convenience, both options being noted as the “telephone keypad” herein) with iconic and textual representations of commands/functions being displayed juxtaposed to the image of the numeric key. The user can then activate a selected key on the telephone keypad to activate one of the displayed commands/functions. A home page display is used to provide a baseline point of reference from which the user can select one of a plurality of basic functions that include reading messages, generating messages as well as accessing various administrative functions and predetermined stock message icons and/or pre-made cards.

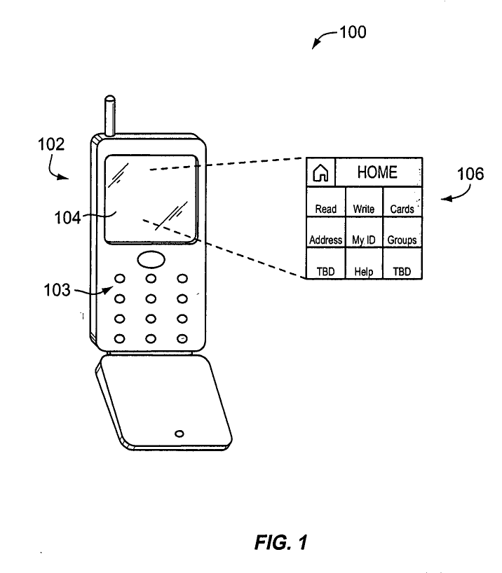

FIG. 1 illustrates the preferred embodiment 100 of the wireless communications device GUI basic home page display that displays a plurality of fundamental command options as incorporated into a wireless communications device 102. The wireless communications device 102 has a display 104 which displays the graphical user interface display 106. The wireless communications device 102 also includes a telephone keypad 103 for entering commands and text to the graphical user interface.

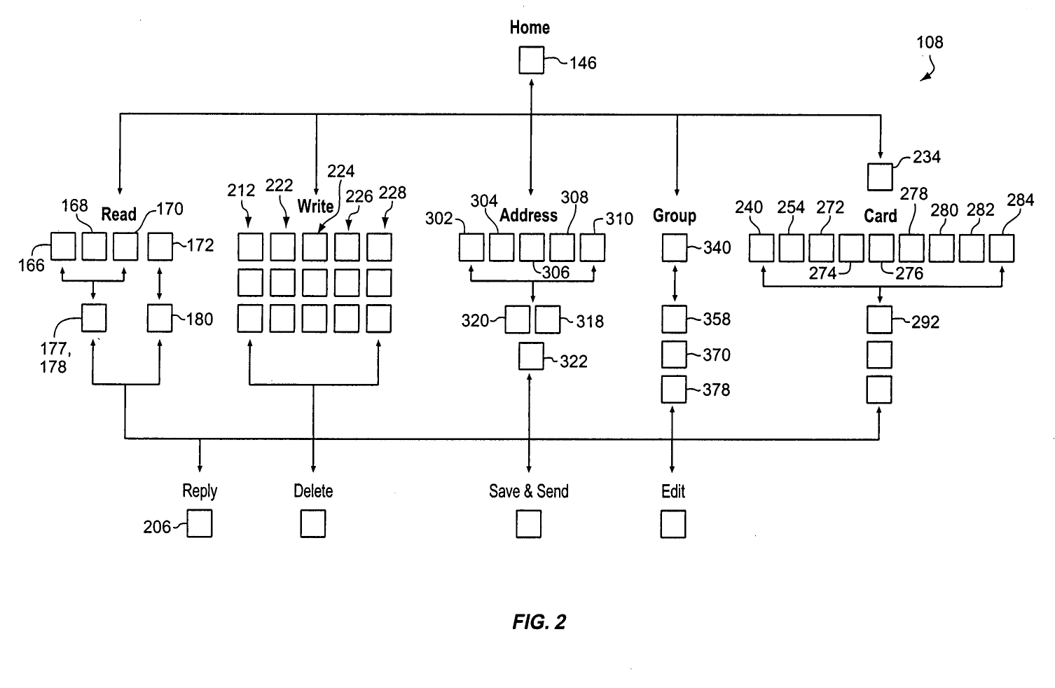

FIG. 2 illustrates a hierarchical set of commands that integrate the displays generated on the graphical display with the standard 12-button telephone keypad. The various boxes below each function to illustrate the hierarchical set of commands 108 of the wireless communications device GUI.

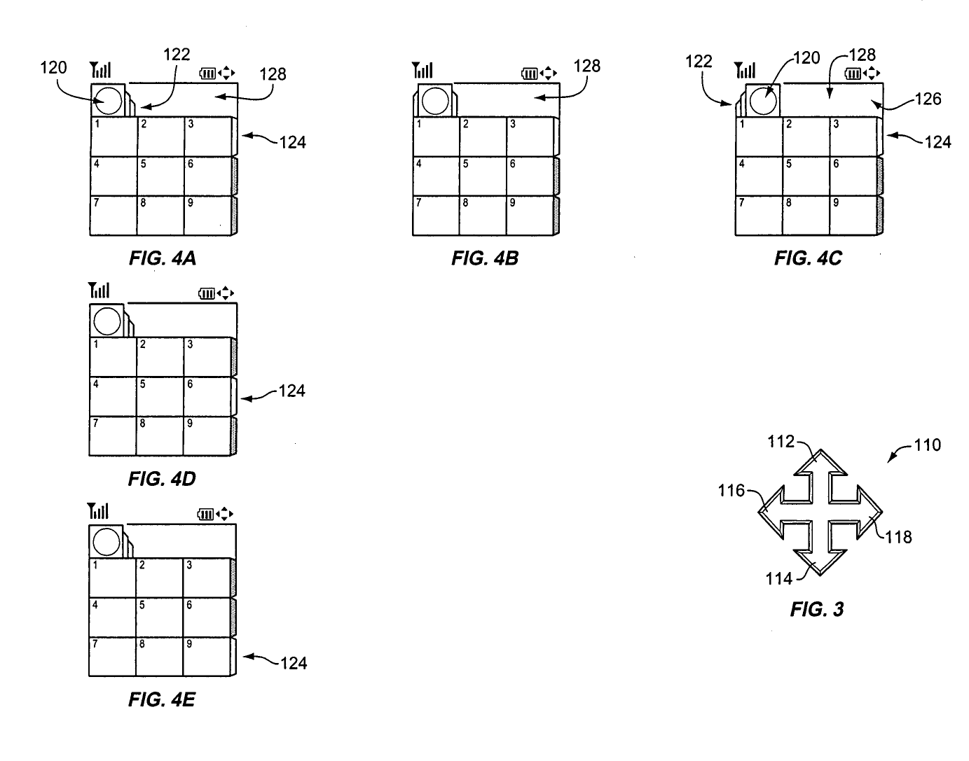

FIG. 3 illustrates a set of arrow command keys 110 of a wireless communication device that navigate throughout the wireless communications device GUI. The arrow command keys include the up arrow 112, down arrow 114, right arrow 118, and left arrow 120 keys commonly found on most wireless communication devices.

FIGS. 4A-4E illustrate various positional indicia reflecting a position within the hierarchical set of commands of the wireless communications device GUI. FIG. 4A illustrates a typical display including a 3×3 grid that is associated with the alphanumerical keys on a standard 12-button telephone keypad. FIG. 4A includes a deck icon 120 that depicts the present page of the display. FIG. 4A may include a category tab 122 and a page tab 124. Category tabs are present when there are more than one categories associated with the present function. As shown in FIG. 4A, the tabs are all on the right side of the deck icon 120. This shows that the display is the first in a set of categories available to be selected by user. The right arrow 118 and left arrow 116 are used to navigate between and among the different categories. Users may move through categories of information by using the left arrow 116 and the right arrow 118. The page tab 124 indicates the position among pages in a specific category. If more than one page exists in a category, the page tab 124 will show a bar with contrasting colors to indicate the position among the pages. In FIGS. 4A-4C, the lighter color section of the page tab 124 is located at the top of the page tab 124, which indicates that the user is viewing the top page in the category.

In FIG. 4B, the category tabs 122 are shown on both sides of the deck icon 120, this indicates that the user has selected a category that is somewhere in between the first and last category. In FIG. 4C all of the category tabs 122 are shown on the left of the deck icon 120, this indicates that the user has reached one end of the categories. Also in FIG. 4C, a message indicator 126 is shown, which indicates that more of a message exists than can be shown in the message/title field 128. In FIG. 4D, the page tab 124 bar has a lighter color in the middle of the bar indicating that the user is viewing pages between the first and last page of the category selection. In FIG. 4E, the page tab 124 bar has a lighter color at the bottom of the bar indicating that the user is viewing the last page of the category selection. The up arrow 112 and down arrow 114 of the arrow command keys 110 to navigate between the different pages of the category.

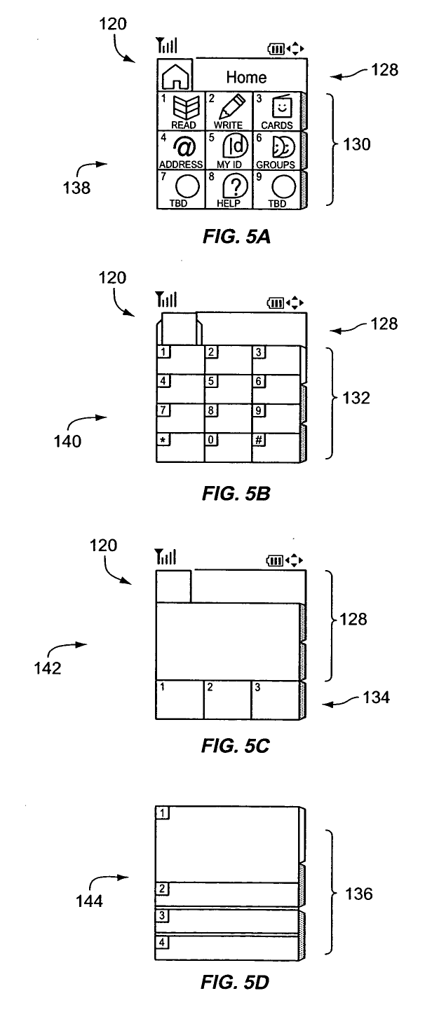

FIGS. 5A-5D illustrate various different arrangements of the graphical display which produces an image of all or a selected part of the standard 12-button telephone keypad. In FIG. 5A, deck icon 120 illustrates the current category, such as the home category, that the user is viewing. In one aspect of the present graphical user interface display 106, a 3×3 cell layout 138 is displayed to the user. This 3×3 cell layout 138 includes a 3×3 cell array 130 which comprises nine individual cells or squares, each cell or square is directly associated with a number on the telephone keypad of the wireless communications device 102. In FIG. 5B, another aspect of the present graphical user interface display 106, a 3×4 cell layout 140 is displayed to the user. This 3×4 cell layout 140 includes a 3×4 cell array 132 which comprises twelve individual cells or squares, each cell or square is directly associated with a number on the telephone keypad of the wireless communications device 102. In FIG. 5C, another aspect of the present graphical user interface display 106, a 3×1 cell layout 142 is displayed to the user. This 3×1 cell layout 142 includes a 3×1 cell array 134 which comprises 3 individual cells or squares, each cell or square is directly associated with a number on the telephone keypad of the wireless communications device 102. In FIG. 5D, another aspect of the present graphical user interface display 106, a list view layout 144 is displayed to the user. This list view layout 144 includes a list view 136 which comprises one or many cells or squares arranged one on top of another. The aforementioned cells or squares are displayed to enable a user to select any of the following, options that appear in the graphical user interface display 106, by selecting the appropriate number on the telephone keypad.

Card assets are preferably split into 3 categories: mocab symbol, scene (background), and groove (music track). Mocab symbols always appear in the #1, #2, and #3 boxes within the 3×3 cell layout 138. Scenes always appear in the #4, #5, and #6 boxes within the 3×3 cell layout 138. Music tracks always appear in the #7, #8, and #9 boxes within the 3×3 cell layout 138.

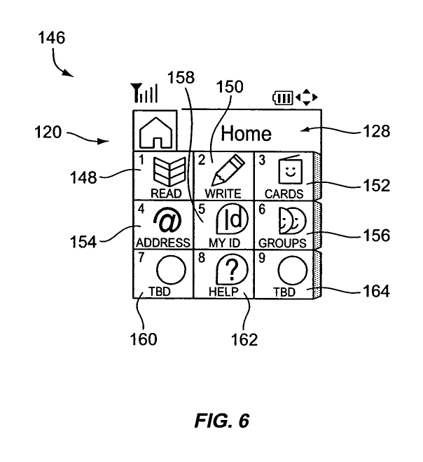

FIG. 6 illustrates an embodiment of the graphical user interface display 106 of the present wireless communications device GUI home page display 146. Preferably, the home page display 146 includes a deck icon 120 which indicates the category that the user is presently viewing and a message/title field 128 which indicates the title or message of a category. Further, the home page display 146 includes a read messages cell 148, a write messages cell 150, a compose card cell 152, an address message cell 154, a group cell 156, an edit ID cell 158, a help topic cell 162, and other cells such as the TBD cells 160 and 164.

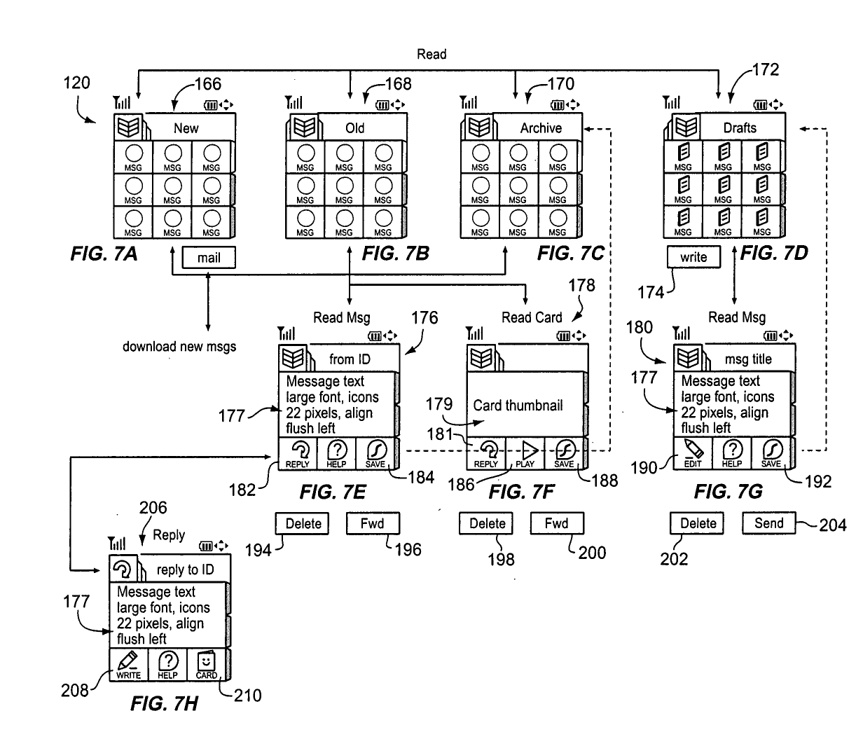

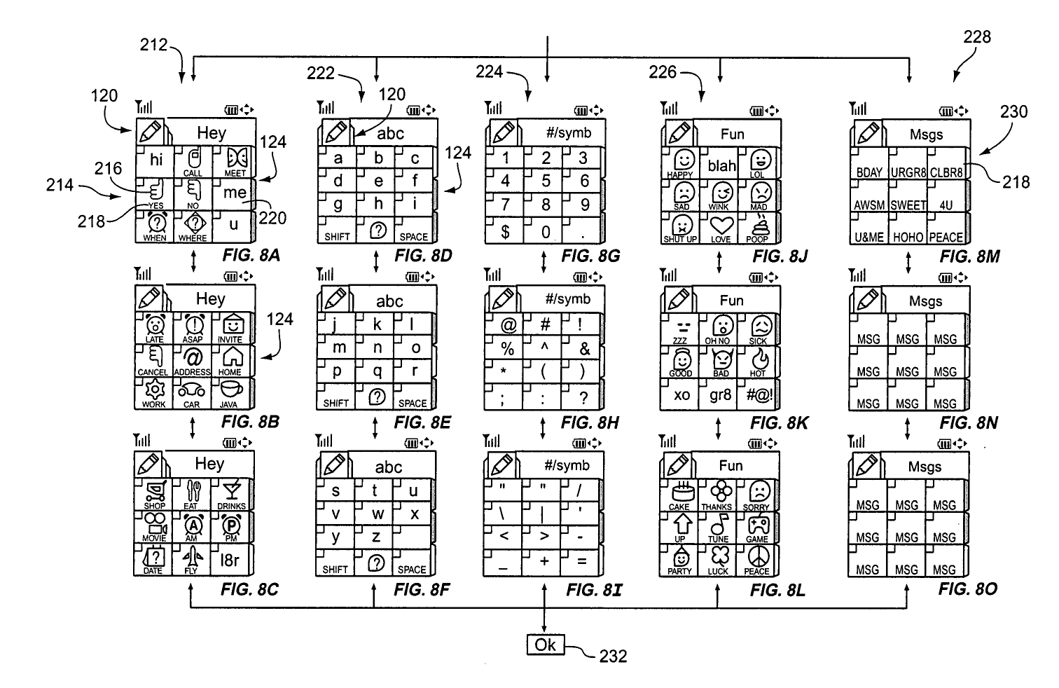

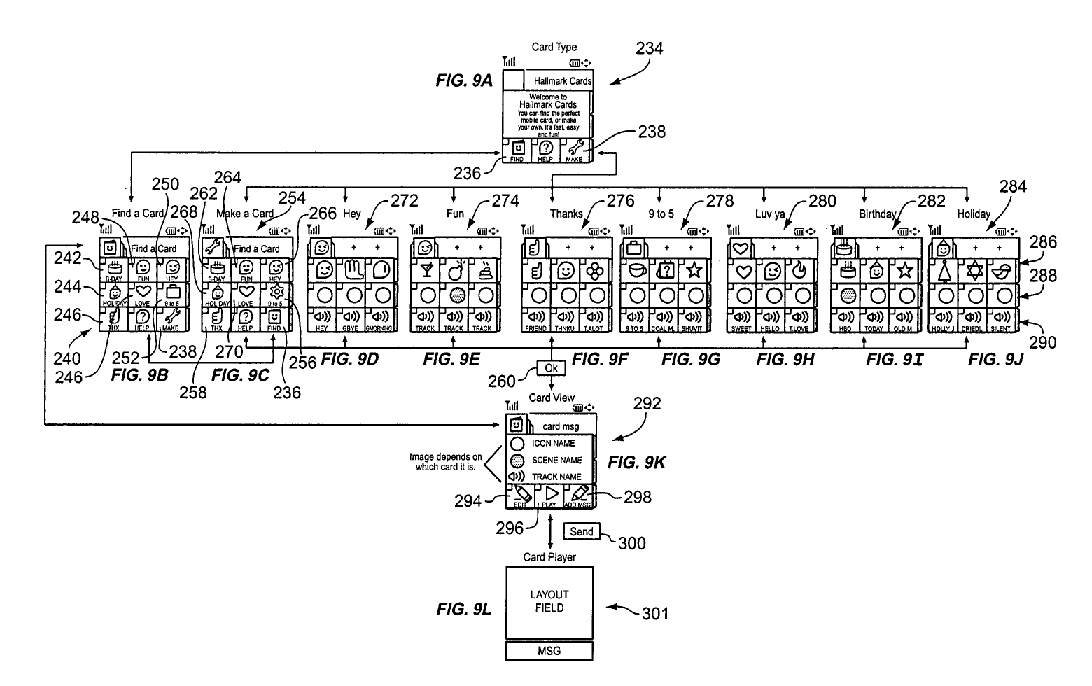

FIG. 7A illustrates the read new display 166 that is displayed when the user selects the read messages cell 148 from the home page display 146. Preferably, the read new display 166 includes new messages that the user has not viewed previously. From the read new display 166 the user can arrow to the right to display the read old display 168, as shown in FIG. 7B. Once a new message has been read, it is preferably automatically stored in the read old display 168, regardless of message type. Preferably, these old messages are purged after a pre-set period of time, such as 14 days. The read old display 168 includes messages that the user has previously viewed and that are displayed in the read old display 168. From the read old display 168 the user can arrow to the right to display the read archive display 170, as shown in FIG. 7C, which includes messages that the user has saved to the read archive display 170. From the read archive display 170 the user can arrow to the right to display the read drafts display 172, as shown in FIG. 7D. The read drafts display 172 includes messages that have been drafted by haven't been sent. The read drafts 172 display preferably includes a write softkey 174. When the write softkey 174 is selected, the write hey category displays 212 of FIG. 8A is displayed on the graphical user interface display 106.

When any of the cells containing messages, of the read new display 166 or the read old display 168 or the read archive display 170 are selected, the read message display 176 or the read card display 178 is displayed, as shown in FIG. 7E and FIG. 7F. The read message display 176 includes the identification (ID) of the sender of the message in the message/title field 128. Preferably included on the read message display 176 are a read message reply cell 182 and a read message save/send cell 184. Further, when any of the cells, containing cards, of the read new display 166 or the read old display 168 are selected, the read card display 178 is displayed, as shown in FIG. 7F. The read message display 176 includes textual display 177, where the messages are displayed. Also, the read message display 176 preferably includes a read message delete softkey 194, which when activated displays the delete confirmation display 384, which will be described in detail below. The read message display 176 also includes read message forward softkey 196, which will be described in detail below.

In FIG. 7F, the read card display 178 is illustrated, which displays the card messages that are selected from the displays 166, 168, and 170. Preferably, the read card display 178 includes a card display 179 that is generally a single frame of the display of the card. The read card display 178 includes a read card reply cell 181 and a read card save cell 188. Also, the read card display 178 includes a read card play cell 186, which plays the card visually and audibly on the graphical user interface display 106. The read card display 178 preferably also includes a read card delete softkey 198 and a read card forward softkey 200, which both will be described in detail below.

In FIG. 7G, the read draft display 180 is illustrated, which displays the draft messages that have been selected from the read drafts display 172. The read draft display 180 includes a textual display 177, a read draft edit cell 190, and a read draft save cell 192. When the read draft save cell 192 or the read message save/send cell 184 are selected, the card or message is saved in the read archive display 170. The read draft display 180 also preferably includes a read draft delete softkey 202 which will be described in detail below. The read draft display 180 also preferably includes a read draft send softkey 204, which when selected either the save/send display if addressed or the address messages A-L display 302, to be addressed.

When the read message delete softkey 194, the read card delete softkey 198 or the read draft delete softkey 202 are selected, then the wireless communications device GUI displays the delete confirmation display 384, which will be described in detail below. When the read message forward softkey 196 or the read card forward softkey 200 are selected, then the address message A-L display 302 is displayed to the graphical user interface display 106, which will be described in detail below.

When the read message reply cell 182 is selected by a user, the read message reply display 206 is displayed, as shown in FIG. 7H. The message reply display 206 preferably includes a textual display 177, a read message reply write cell 208 and a read message reply card cell 210. When the read message reply write cell 208 is selected, the wireless communications device GUI preferably displays the write hey category displays 212. Selecting the read message reply card cell 210 displays the card type display 234.

FIGS. 8A-8O illustrate an embodiment of the displays of the present wireless communications device GUI 100 write functions. The present arrangement of these categories and pages is one aspect of the present wireless communications device GUI 100. This arrangement may be in any order while continuing in the spirit of the present wireless communications device GUI 100. FIG. 8A illustrates an write hey category displays 212. One or more pages of this category can be displayed, as in FIGS. 8A-8C. FIG. 8A is the first page, FIG. 8B is the second page, and FIG. 8C is the third page of the hey category. Many other pages could exist, and these three are illustrated as an embodiment of the present wireless communications device GUI 100.

FIG. 8A illustrates a write hey category displays 212, which illustrate several cells that include messages that include text, symbols or a combination of both. For example, the write yes cell 214 includes both write cell symbol 216 and a write cell text 218 “YES.” In addition, the write me cell 220 illustrates the word “me” only. As shown in FIGS. 8A-8C, any combination of text and symbols can be created and assigned to a cell relating to a specific key on a telephone keypad. Preferably, these messages are arranged in a 3×3 cell array 130, a 3×4 cell array, or other cell array that may be desired.

FIG. 8D illustrates several cells that include alphabetical characters, as illustrated in the write abc category displays 222. FIG. 8D includes the alphabetical characters A-I and further includes a space key and shift key, like those found on a common keyboard. FIG. 8E includes the alphabetical characters J-R and FIG. 8F includes alphabetical characters S-Z. These alphabetical characters can be selected to write a word by selecting the keypad character associated with the particular alphabetical character. Preferably, these alphabetical characters are arranged in a 3×3 cell array 130, a 3×4 cell array, or other cell array that may be desired.

FIG. 8G illustrates several cells that include numerical characters and symbols, as illustrated in the write #/symbols category displays 224. FIG. 8G includes numerical characters 0-9, the “$” symbol, and the “.” These numerical characters and symbols can be selected to write messages by selecting the keypad character associated with the particular numerical character or symbol. FIGS. 8H-8I illustrates additional symbols that can be used to write messages. Preferably, these alphabetical characters are arranged in a 3×3 cell array 130, a 3×4 cell array, or other cell array that may be desired. FIGS. 8J-8L illustrate several cells that include other text, symbols and a combination of them both, as illustrated in the write fun category displays 226. In addition, FIGS. 8M-8O illustrate several cells that include single word messages, as illustrated in the write messages category displays 228. In one example of these write messages category displays 228, the word “celebrate” is abbreviated and is illustrated as the word “CLBR8” in the celebrate cell 218. Other cells can be created by a user and assigned to one or all of these displays.

Once a message has been written by selecting among the cells illustrated in FIGS. 8A-8O, the message appears in the message/title field 128. The write ok softkey 232 is selected to return to the originating function. For example, if the originating function was the groups function, then selecting the write ok softkey 232 returns the message to the address groups message display 310. If the originating function was the ID address function, then selecting the write ok softkey 232 returns the message to the address message A-L display 302. If the originating function was the write function, then selecting the write ok softkey 232 returns the message to the save/send display 390. If the originating function is the card view function, then selecting the write ok softkey 232 returns the message to the card view display 292.

FIG. 9A illustrates an embodiment of the display of the present wireless communication device GUI 100 card type display 234. The card type display 234 includes a find card cell 236 and a make card cell 238. The help topic cell 162 is also preferably included in the card type display 234. If the find card cell 236 is selected, then the find card display 240 is displayed to the graphical user interface display 106, as is illustrated in FIG. 9B. The find card display 240 preferably includes a find card birthday cell 242, a find card holiday cell 244, a find card thanks cell 246, a find card fun cell 248, a find card hey cell 250, and a find card work cell 252. These cells 242, 244, 246, 248, 250, and 252 are each individually associated to a different key in a standard telephone keypad. For example, the find card birthday cell 242 can be activated by pressing the “1” on a standard telephone keypad of the wireless communications device 102. Also, the particular arrangement and types of these cells may be arranged in another arrangement and comprise different types. Also, a help topic cell 162 is also preferably included in the find card display 240. Preferably, when cells 242, 244, 246, 248, 250, and 252 are activated other displays of related types of pre-made animated or static cards for the user to select from. The cells 242, 244, 246, 248, 250, and 252 are activated by pressing the corresponding key on the keypad of the wireless communications device 102.

When the make card cell 238 is selected, the make card display 254 is to the graphical user interface display 106, as illustrated in FIG. 9C. The make card display 254 preferably includes a make card hey cell 256, a make card thanks cell 258, a make card birthday cell 262, a make card fun cell 264, a make card work cell 266, a make card holiday cell 268, and a make card love cell 270. Preferably, the make card display 254 also includes a help topic cell 162. In addition, the make card display 254 also includes the find card cell 236, which when activated displays the find card display 240. The cells 256, 258, 262, 264, 266, and 270 are activated by pressing the corresponding key on the keypad of the wireless communications device 102.

FIG. 9D illustrates the make card hey category display 272 that is displayed to the graphical user interface display 106 when the make card hey cell 256 is selected. FIG. 9E illustrates the make card fun category display 274 that is displayed to the graphical user interface display 106 when the make card fun cell 264 is selected. FIG. 9F illustrates the make card thanks category display 276 that is displayed to the graphical user interface display 106 when the make card thanks cell 258 is selected. FIG. 9G illustrates the make card work category display 278 that is displayed to the graphical user interface display 106 when the make card work cell 266 is selected. FIG. 9H illustrates the make card love category display 280 that is displayed to the graphical user interface display 106 when the make card love cell 270 is selected. FIG. 9I illustrates the make card birthday category display 282 that is displayed to the graphical user interface display 106 when the make card birthday cell 262 is selected. FIG. 9J illustrates the make card holiday category display 284 that is displayed to the graphical user interface display 106 when the make card holiday cell 268 is selected. The make card hey category display 272, make card fun category display 274, make card thanks category display 276, make card work category display 278, make card love category display 280, make card birthday category display 282, and make card holiday category display 284 preferably include icons, symbols, and text for a user to create a static or animated card.

FIGS. 9D-9J preferably contain a selection of icons as illustrated by the row of icon name 286. Preferably, the row of icon name 286 is the top row of the 3×3 cell array 130. Further, FIGS. 9D-9J preferably contain a selection of scenes as illustrated by the row of scene name 288. Preferably, the row of scene name 288 is the middle row of the 3×3 cell array 130. In addition, FIGS. 9D-9J preferably contain a selection of track names as illustrated by the row of track name 290. Preferably, the row of track name 290, is the bottom row of the 3×3 cell array 130. As these icons, symbols and text are being selected, they are displayed in the message/title field 128.

Once a message has been created, the user selects the make ok softkey 260 to display the card view display 292 as illustrated in FIG. 9K. The card view display 292 displays the icon, scene, and track that the user has selected in addition to the text message. The card view display 292 further includes an edit card view cell 294, a play card view cell 296, and an add message card view cell 298. When the edit card view cell 294 is selected, the save/send edit display 402 is displayed, which will be discussed in detail below. The card view display 292 also includes a send card softkey 300, which when selected sends the message if it is addressed, or to the address message A-L display 302 if it is not addressed. Additionally, the card view display 292 preferably includes a add message card view cell 298 that when selected displays the write hey category display 212. When the play card view cell 296 is selected, the card player display 301 is displayed as illustrated in FIG. 9L, which plays the created message on the card player display 301.

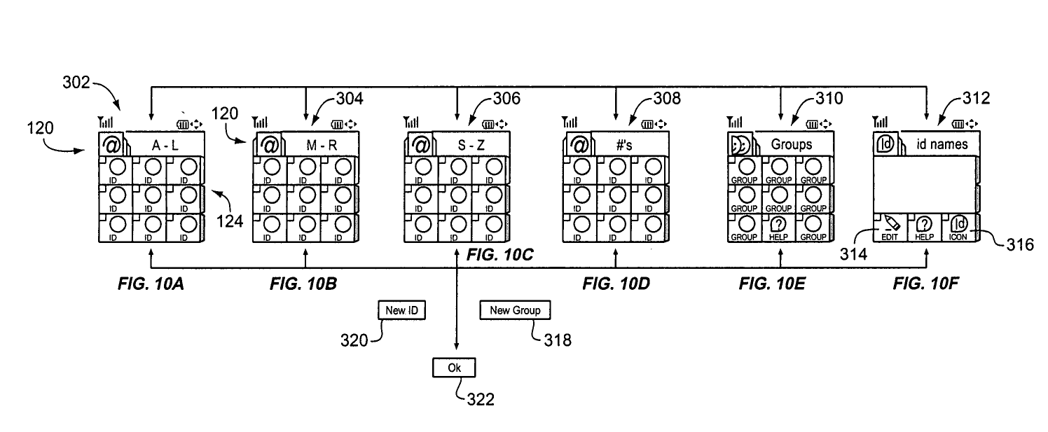

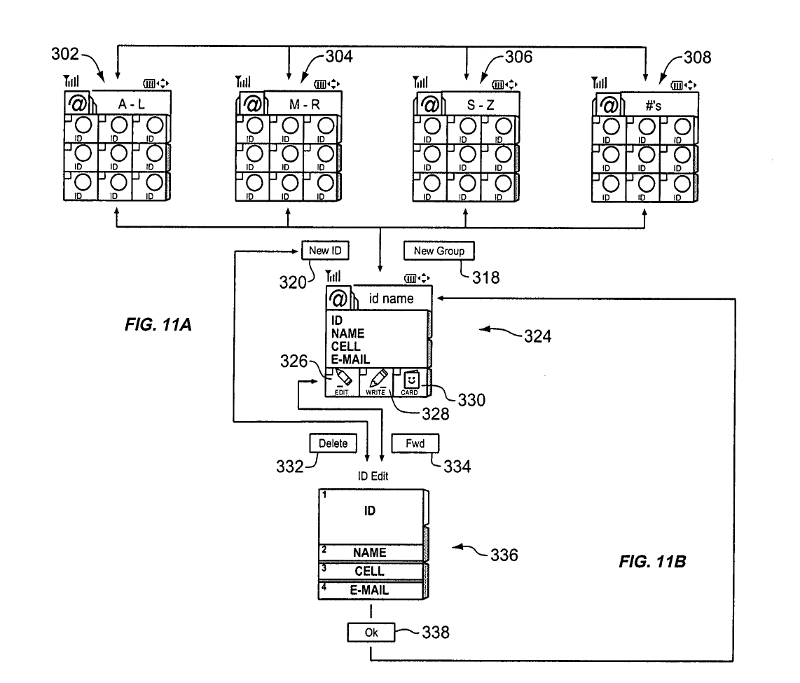

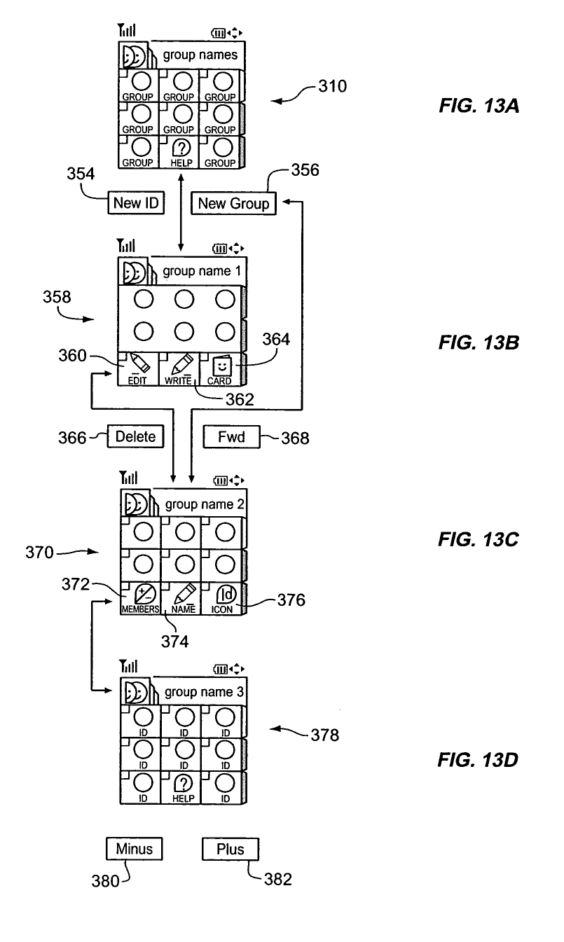

FIG. 10A illustrates an embodiment of the display of the present wireless communications device GUI address messages functions. The address message A-L display 302, as illustrated in FIG. 10A, includes the addresses of recipients whose names begin with A-L of the alphabet. FIG. 10B illustrates the address message M-R display 304 and FIG. 10C illustrates the address message S-Z display 306. FIG. 10D includes the identification (ID) numbers of recipients as illustrated in the address message numbers display 308 and FIG. 10E includes the name of a group of recipients as illustrated in an address message groups display 310. Further, FIG. 10F includes the ID names of the recipients as illustrated in an address message ID name display 312. The address message ID name display 312 includes an address message edit cell 314, which when selected displays the edit ID input display 336, described in detail below. In addition, the address message ID name display 312 further includes an address message ID icon cell 316, which when selected displays the edit your ID display 340, described in detail below. FIGS. 10A-10F include an address messages new group softkey 318, which when selected displays the edit group display 370, as illustrated in FIG. 13C. FIGS. 10A-10F also include an address messages new ID softkey 320, which when selected displays the edit ID input display 336. When the address messages ok softkey 322 is selected the address display 324 is displayed to the graphical user interface display 106, as illustrated in FIG. 11A.

In FIG. 11A, the address display 324 includes the ID, name, cell phone number, and email address of the recipients in the message/title field 128. In addition, the address display 324 further includes the edit address cell 326, which when selected, the graphical user interface display 106 displays the edit ID input display 336, as shown in FIG. 11B. Further, the address display 324 preferably includes a write message cell 328, which when selected, the graphical user interface display 106 displays the write hey category display 212. Additionally, the address display 324 also preferably includes a create card cell 330, which when selected, the graphical user interface display 106 displays the card type display 234. The address display 324 also preferably includes a delete address softkey 332, which when selected displays the delete confirmation display 384. Also, the address display 324 includes a forward address softkey 334, which when selected displays the address message A-L display 302. Upon selection of the edit ID ok softkey 338, the graphical user interface display 106 displays returns to the address display 324.

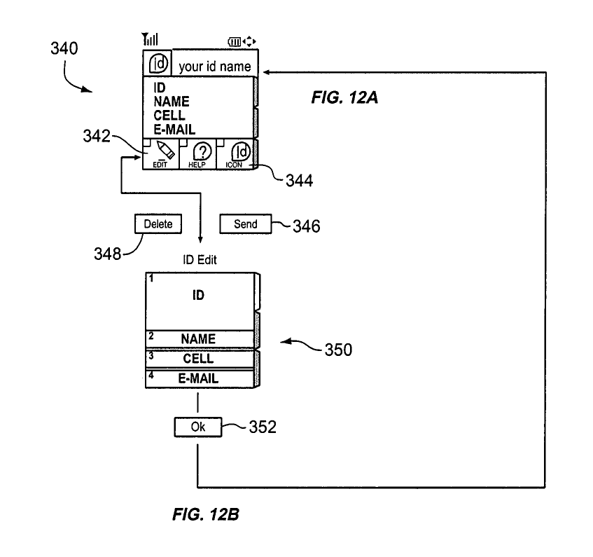

FIG. 12A illustrates the edit your ID display 340. The edit your ID display 340 includes a display of the ID, name, cell phone number, and email address of the user. The edit your ID display 340 also includes an edit your ID cell 342, which when selected, the graphical user interface display 106 displays the edit ID input display 350, which inputs user's ID edits into the edit ID input display 350, as illustrated in FIG. 12B. The edit your ID display 340 further includes a ID icon cell 344, which when selected, the graphical user interface display 106 displays the card type display 234. The edit your ID display 340 further includes a edit ID send softkey 346, that when selected, the graphical user interface display 106 displays the address message A-L display 302. The edit your ID display 340 further includes an edit ID delete softkey 348, which when selected, the graphical user interface display 106 displays the delete confirmation display 384. Once the edits to the user ID are completed, the edit ID ok softkey 352 is selected and the graphical user interface display 106 displays the edit your ID display 340.

FIG. 13A illustrates the address message groups display 310. When on of the groups are selected from those displayed, the graphical user interface display 106 displays the group display 358. The address message groups display 310 includes an edit group new ID softkey 354, which when selected, the graphical user interface display 106 displays the edit your ID display 340. The address message groups display 310 also includes an edit group new group softkey 356. In FIG. 13B, the group display 358 includes an edit group cell 360, a write message group cell 362, and a write card group cell 364. When the edit group cell 360 is selected, the graphical user interface display 106 displays the edit group display 370. When the write message group cell 362 is selected, the graphical user interface display 106 displays the write hey category displays 212. When the write card group cell 364 is selected, the graphical user interface display 106 displays the card type display 234 is displayed. The group display 358 also preferably includes a delete group softkey 366, which when selected, the graphical user interface display 106 displays the delete confirmation display 384. The group display 358 also includes a forward group softkey 368, which when selected, the graphical user interface display 106 displays the address message A-L display 302.

The edit group display 370 preferably includes a edit group members cell 372, a edit name cell 374, and a edit icon ID cell 376. When the edit group members cell 372 is selected, the graphical user interface display 106 displays the edit group members display 378, as illustrated in FIG. 13D. When the edit name cell 374 is selected, the graphical user interface display 106 displays the write hey category displays 212. When the edit icon ID cell 376 is selected, the graphical user interface display 106 displays the card type display 234. The edit group members display 378 preferably includes a minus group softkey 380, that when selected a minus sign appears in the message/title field 128 to the far left indicating that the user has chosen to delete something. The selected group appears to the right of the minus sign in the message/title field 128. The edit group members display 378 preferably includes a plus group softkey 382, that when selected the graphical user interface display 106 displays the address message A-L display 302.

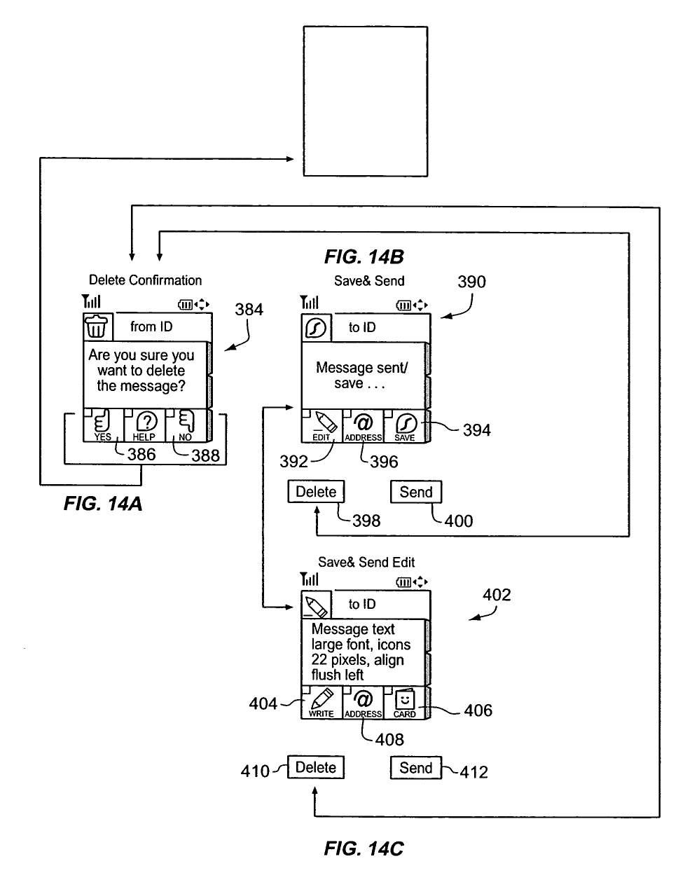

FIG. 14A illustrates the delete confirmation display 384. The delete confirmation display 384 includes a affirmative confirmation display 386 and a negative confirmation display 388. FIG. 14B illustrates the save/send display 390. The save/send display 390 includes an edit save/send cell 392, a save cell 394, and an address save message cell 396. If the address save message cell 396 is selected, the graphical user interface display 106 displays the address message A-L display 302 if the message is not saved and displays the address message groups display 310 if the message is addressed. If the save cell 394 is selected, the graphical user interface display 106 stores the message to the archive or draft in background. The save/send display 390 also includes a save/send delete softkey 398 and a save/send send softkey 400. If the save/send delete softkey 398 is selected, the graphical user interface display 106 displays the delete confirmation display 384. If the save/send send softkey 400 is selected, the graphical user interface display 106 sends the message to the recipient if it is addressed and displays the address message A-L display 302 if it is not addressed.

If the edit save/send cell 392 is selected, the graphical user interface display 106 displays the save/send edit display 402, as illustrated in FIG. 14C. The save/send edit display 402 preferably includes a save/send edit write cell 404, a save/send card cell 406, and a save/send address cell 408. If the save/send edit write cell 404 is selected, the graphical user interface display 106 displays the write hey category displays 212. If the save/send card cell 406 is selected, the graphical user interface display 106 displays the card type display 234. If the save/send address cell 408 is selected, the graphical user interface display 106 displays the address message groups display 310 if the message is addressed and displays the address message A-L display 302 if it is not addressed. The save/send edit display 402 further preferably includes a save/send edit delete softkey 410 and a save/send edit send softkey 412. If the save/send edit delete softkey 410 is selected, then the graphical user interface display 106 displays the delete confirmation display 384. If the save/send edit send softkey 412 is selected, the graphical user interface display 106 sends the message to the recipient if the message is addressed and displays the address message A-L display 302 if the message is not addressed.

The user can choose different elements from any category and in any order by tabbing through categories. The user doesn't have to select all three elements (icons, scenes, and tracks ) when creating a message. The user can mix and match elements from every category. If the user selects the same element type from a different category, the graphical user interface display 106 will replace the previously chosen element of the same type. For example, if the user chooses an icon from the make card fun category display 274, then tabs over and chooses an icon from the make card love category display 280, the make card love category display 280 icon will replace the make card fun category display 280 icon.

The help topic cell 162 when selected preferably brings up a contextual help screen. Users can hit ok or the up arrow 112 to return back to the place within the GUI that he was before he entered the help section, or the user can left arrow 116 and right arrow 118 through the other help categories. Hitting this help topic cell 162 brings up a help screen. Users can view all of the GUI help messages by either hitting the “Next” key (in this instance the #1 numeric key) or by using the right arrow 118 to tab them ‘right’ though the messages in a sequential order. Users can hit the ‘Back’ soft key at any time to take them back to the home page display 146.

Users can, at any time when the “question mark” symbol appears in the #8 key location, bring up a help screen that refers to what the user was doing at that very moment. Once the user is done reading the pertinent information, they have the option of jumping back to where they left off by hitting the up key or tabbing left and/or right through the rest of the help section.

Within Mocab Write, the user can select from a number of symbols and/or text letters or numbers and build a message. This visual message is never actually sent to another cell phone, instead, a coded recipe is sent to the recipients cell phone through our content pipeline, which allows the phone to receive and reassemble the message on the other end.

The GUI enables a user to create and send hundreds of thousands of visual representations of themselves by selecting from individual groups of assets, or parts of symbols, such as eyes, hair, clothes, skin color, etc. This is a visual and secured ‘caller id.’ This visual info is interpreted as a recipe that can be sent to through a content pipeline, reassembled and sent on to a recipient, which the recipient can then save into his address book.

Users can create and send numerous wireless communications device cards by selecting from individual groups of assets such as, mocab icon, scene (background), and music track. By selecting one of each asset and then previewing, the user can assemble a large number of cards from a limited number of assets (i.e. 100 icons×100 scenes×100 tracks=1,000,000 cards).

The GUI is a content ‘skin’ over a user interface and navigational schema that turns the user's wireless communication device into a branded messaging platform. Together, the skin and the interface make it easier and more fun to a user to create and send multimedia messages and/or text/symbol-based icons. The content is dynamically updated via a secure data transmission pipeline.

The GUI is a set of content elements assigned to the functional requirements of an information architecture. Both the architecture and the design elements are preferably assigned a 128-bit identification for cross-network communication, enabling them to be accurately recreated on the intended device.

If an incoming phone call interrupts any text messaging operation, the graphical user interface display 106 returns to the operation or function that was interrupted by the incoming call.

Although there has been described what is at present considered to be the preferred embodiments of the present invention, it will be understood that the invention can be embodied in other specific forms without departing from the spirit or essential characteristics thereof. The present embodiments are, therefore, to be considered in all aspects as illustrative and not restrictive. The scope of the invention is indicated by the appended claims rather than the foregoing description.

What is claimed:

1. A graphical user interface operational on a wireless communication device that is equipped with a graphical display and a telephone keypad, for enabling a user to generate and receive text/symbol-based and multi-media messages using said wireless communication device, comprising:
image display means for presenting a hierarchically organized set of displays to said graphical display, each display in said set of displays presenting a substantial image of a telephone keypad, annotated with at least one of iconic and textual definitions of a function performed by the wireless communication device upon activation of a key in said telephone keypad corresponding to said at least one iconic and textual definitions;
menu means, responsive to activation of a key on said telephone keypad, for determining a present state in said hierarchically organized set of displays to associate a predetermined function with said presently activated key; and
function implementation means for performing said predetermined function comprising a one of a defined communication function and a menu navigation function performed by the wireless communication device upon activation of a key.

2. The graphical user interface of claim 1, wherein said telephone keypad includes navigational means for navigating among said hierarchically organized set of displays.

3. The graphical user interface of claim 1, further comprising:
storing means for storing said text/symbol-based and multi-media messages.

4. The graphical user interface of claim 1, further comprising;
addressing means for addressing said text/symbol-based and multi-media messages.

5. The graphical user interface of claim 1, further comprising:
assembling means, responsive to activation of a key on said telephone keypad, for assembling a message card from preselected iconic and textual definitions.

6. The graphical user interface of claim 5, wherein said iconic definitions include parts of said iconic definitions.

7. The graphical user interface of claim 6, wherein said card comprises assets selected from the group consisting of text, symbol, icon and multi-media data.

8. The graphical user interface of claim 5, wherein said card comprises assets selected from the group consisting of text, symbol, icon, and multi-media data.

9. The graphical user interface of claim 1, further comprising:
encryption means for encrypting said text/symbol-based and multi-media messages.

10. The graphical user interface of claim 1, further comprising:
positional indicia, responsive to activation of a key on said telephone keypad, for displaying the relative position of a present display within said hierarchically organized set of displays.

11. The graphical user interface of claim 10, wherein positional indicia are responsive to said activation of said telephone keypad.

12. The graphical user interface of claim 5, further comprising:
previewing means, responsive to activation of a key on said telephone keypad, for previewing said assembled text/symbol-based multi-media message on said graphical display.

13. The graphical user interface of claim 5, further comprising:
transmitting means, responsive to activation of a key on said telephone keypad, for transmitting said assembled card from said wireless communications device.

14. The graphical user interface of claim 1, wherein said wireless communication device is capable of transmitting and receiving said text/symbol-based and multi-media messages.

15. The graphical user interface of claim 1, further comprising:
displaying, responsive to activation of a key on said telephone keypad, said text/symbol-based and multi-media messages on said graphical display for a user to view.

16. The graphical user interface of claim 15, further comprising:
archiving means, responsive to activation of a key on said telephone keypad, for storing said viewed text/symbol-based and multi-media messages.

17. The graphical user interface of claim 1, wherein said images are selected from the group consisting of 3×1 cell arrangements, 3×3 cell arrangements, and 4×3 cell arrangements.

18. The graphical user interface of claim 1, wherein said predetermined function is selected from the group consisting of read, write, cards, address, ID, groups, and help.

19. The graphical user interface of claim 18, wherein said read function includes the functions of: read new display, read old display, read archive display, and read drafts display.

20. A method for generating a text/symbol-base message using a graphical user interface operational on a wireless communication device that is equipped with a graphical display and a telephone keypad comprising:
presenting a hierarchically organized set of displays, each display in said set of displays presenting a substantial image of a telephone keypad, annotated with at least one of iconic and textual definitions of a function performed by the wireless communication device upon activation of a key in said telephone keypad corresponding to said at least one iconic and textual definitions;
responsive to activation of a key on said telephone keypad, determining a present state in said hierarchically organized set of displays to associate a predetermined function with said presently activated key; and
performing said predetermined function comprising a one of a defined communication function and a menu navigation function performed by the wireless communication device upon activation of a key.

21. The method of claim 20, further comprising:
displaying a plurality of write display cells, said write display cells including at least one asset selected from the group consisting of icons, text, and icons/text;
selecting one of said write display cells corresponding to said icons, text, and icons/text; and
displaying said selected icons, text, and icons/text.

22. The method of claim 21, further comprising:
displaying a plurality of audio display cells; and
selecting one of said audio display cells corresponding to audio data.

23. The method of claim 22, further comprising:
assembling said selected icons, text, and audio data into said text/symbol-base message

24. The method of claim 23, further comprising:
previewing said assembled text/symbol-base message on said graphical display.

25. The method of claim 21, wherein said assets are predetermined administrative functions and predetermined stock message icons and or pre-made cards.

26. The method of claim 23, further comprising:
transmitting said text/symbol-base message from said wireless communications device.

27. A method for viewing a text/symbol-base message using a graphical user interface operational on a wireless communication device that is equipped with a graphical display and a telephone keypad, presenting a hierarchically organized set of displays, each display in said set of displays presenting a substantial image of a telephone keypad, annotated with at least one of iconic and textual definitions of a function performed by the wireless communication device upon activation of a key in said telephone keypad corresponding to said at least one iconic and textual definitions, responsive to activation of a key on said telephone keypad, determining a present state in said hierarchically organized set of displays to associate a predetermined function with said presently activated key, and performing said predetermined function comprising a one of a defined communication function and a menu navigation function performed by the wireless communication device upon activation of a key, said method comprising:
receiving said text/symbol-base messages from a sender;
displaying said text/symbol-base message in an inbox;
selecting said text/symbol-base message to play; and
playing said text/symbol-base message.

28. A method as in claim 27, further comprising:
displaying a reply function for replying to said viewed text/symbol-base message;
selecting said reply function on said telephone keypad;
displaying a set of assets for building a reply to said viewed text/symbol-base message; and
selecting said assets to create a reply text/symbol-base message.

29. A method as in claim 27, further comprising:
transmitting said reply text/symbol-base message said sender.
